(19) United States
(12) Patent Application Publication
(10) Pub. No.: US 2011/0291923 A1
(43) Pub. Date: Dec. 1, 2011

(54) APPLICATION DEVICE OF ELECTRONIC PAPER SOFTWARE

(76) Inventor: Ciao Yu TONG, New Taipei City (TW)

(21) Appl. No.: 13/117,138

(22) Filed: May 27, 2011

(30) Foreign Application Priority Data
May 28, 2010 (TW) 099210144

(51) Int. Cl. G06F 3/01

(52) U.S. Cl. 345/156

(57) ABSTRACT

The present invention relates to an application device of electronic paper software, generally including a first flexible display module, a second flexible display module, and a flexible input module, wherein the second flexible display module is formed on one side of the first flexible display module and the flexible input module extends from one side of the first flexible display module or the second flexible display module. The first flexible display module and the second flexible display module may display various and different use interfaces and display interfaces to thereby provide a digital product that is of low power consumption, light-weight and compactness, water resistance, vibration resistance, and being hard to break.

### (a) TECHNICAL FIELD OF THE INVENTION

The present invention generally relates to an application device of electronic paper software, and more particularly to an application device of electronic paper software that features light-weight and compactness, water resistance, vibration resistance, and being hard to break.

### (b) DESCRIPTION OF THE PRIOR ART

With the progress of science and technology, modern people put a strong and increasingly severe demand for electronic products, which are now becoming a must of modern living. An example of such necessary electronic products of modern living is computers. Both household needs and office operations are within the expansion of applications of computers.

Early computers used by person users are desktop type computers and thus must be set at a fixed site and cannot be carried by a user as a portable device. This is quite troublesome for business persons or those that desire to use computers at various sites. A notebook computer overcomes such a problem. However, the notebook computer is still of a substantial weight, which becomes a load for a user who must carry the notebook computer for quite a long time. Further, the notebook computer requires substantial power consumption and may often run out of power storage, if not timely recharged. Further, a notebook computer is, to some extent, bulky and weight and once falling to the ground, the notebook computer may get broken and thus malfunctioning. Expense for maintenance and repairing would become a burden for the user.

Thus, it is desired to provide a device to overcome the above discussed problems.

### SUMMARY OF THE INVENTION

In view of the above problems, the present invention aims to provide an application device of electronic paper software, which features light-weight and compactness, water resistance, vibration resistance, and being not easy to break.

The primary objective of the present invention is that a first flexible display module and a second flexible display module are provided to display various and different use interfaces and display interfaces to thereby provide a digital product of low power consumption, light-weight and compactness, water resistance, vibration resistance, and being hard to break.

To achieve the objective, the present invention provides an application device of electronic paper software, which generally comprises a first flexible display module, a second flexible display module, and a flexible input module, wherein the second flexible display module is formed on one side of the first flexible display module and the flexible input module extends from one side of the first flexible display module or the second flexible display module, whereby the flexible display modules and/or the flexible input module may function to receive input of information.

The second objective of the present invention is that an enclosure cover is provided to cover the first flexible display module, the second flexible display module, and the flexible input module to provide an overall aesthetic outside appearance and to protect the outside appearance from damages caused by being scratched.

A further objective of the present invention is that an integral combination of flexible display modules is provided to allow of being shaped as for example an electronic book, a flexible digital touch pad, and other digital touch control interface as desired by a user.

The foregoing objectives and summary provide only a brief introduction to the present invention. To fully appreciate these and other objects of the present invention as well as the invention itself', all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment according to the present invention.

FIG. 2 is a perspective view illustrating a bent condition of the preferred embodiment according to the present invention.

FIG. 3 is a schematic view illustrating an application of the present invention to a notebook computer.

FIG. 4 is a schematic view illustrating an application of the present invention to an electronic book.

FIG. 5 is a schematic view illustrating an application of the present invention to a notebook.

FIG. 6 is a schematic view illustrating a stowed condition of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

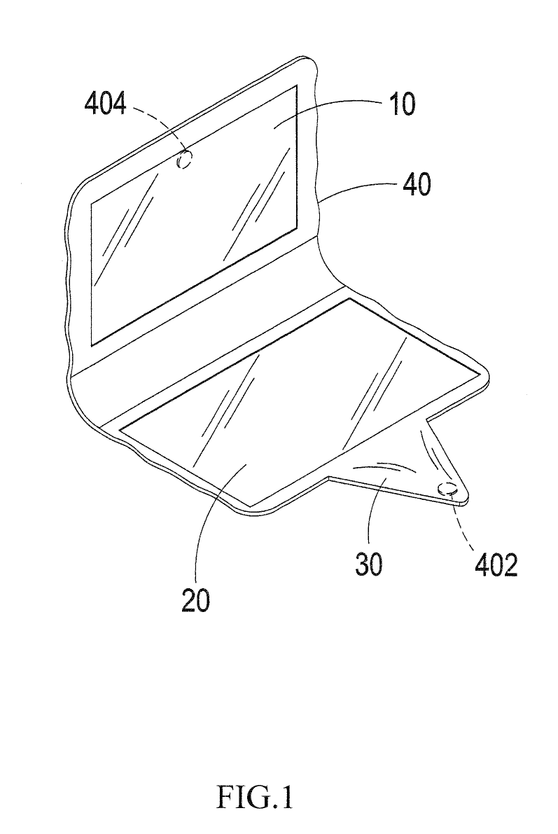

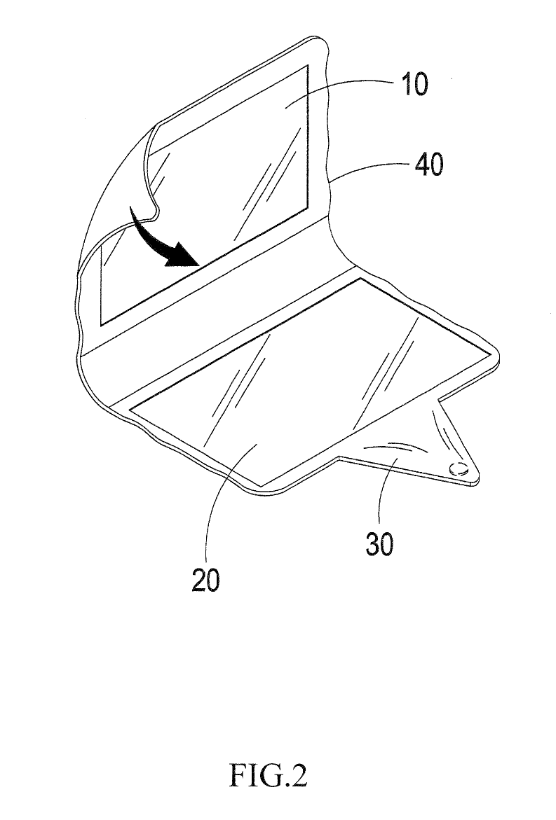

Referring to FIGS. 1 and 2, which are respectively a perspective view illustrating a preferred embodiment according the present invention and a perspective view illustrating a bent condition of the preferred embodiment according to the present invention, the drawings clearly show that the present invention provides an application device of electronic paper software, which generally comprises a first flexible display module 10, a second flexible display module 20, and a flexible input module 30, wherein the second flexible display module 20 is formed at one side of the first flexible display module 10 and the flexible input module 30 extends from one side of the first flexible display module 10 or one side of the second flexible display module 20 for receiving input of information.

Further, an enclosure cover 40 is provided to cover the first flexible display module 10, the second flexible display module 20, and the flexible input module 30. The enclosure cover 40 forms thereon a fastening element 402 and a fastened element 404.

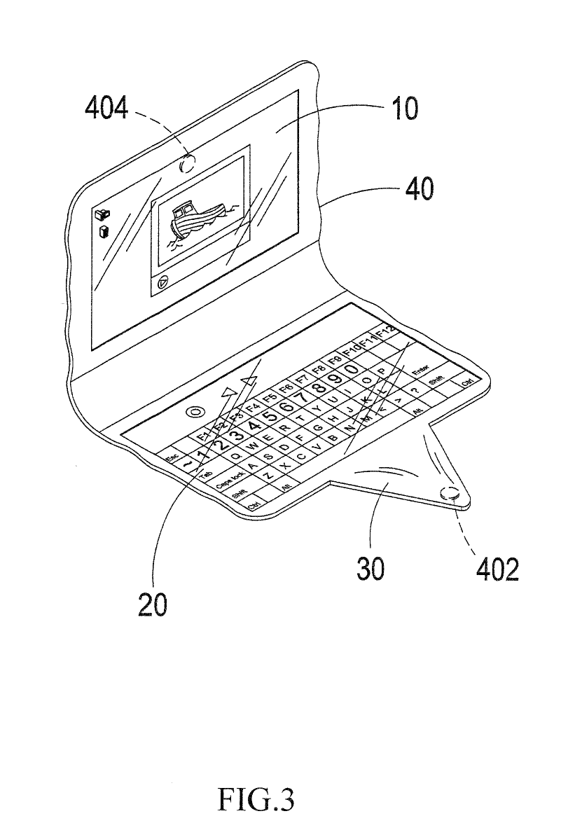

With the above described structure and arrangement, the operation of the present invention will be described as follows. Referring to FIG. 3, a schematic view illustrating an application of the present invention to a notebook computer is shown. The drawing clearly shows that the first flexible display module 10 is used to display information that is regularly displayed on a computer screen, while the second flexible display module 20 displays an image of input keys. The input keys displayed on the second flexible display module 20 can be operated to control the programs and icons shown on the first flexible display module 10. Further, the flexible input module 30 may be used replace a mouse that is regularly used in combination with a conventional notebook computer.

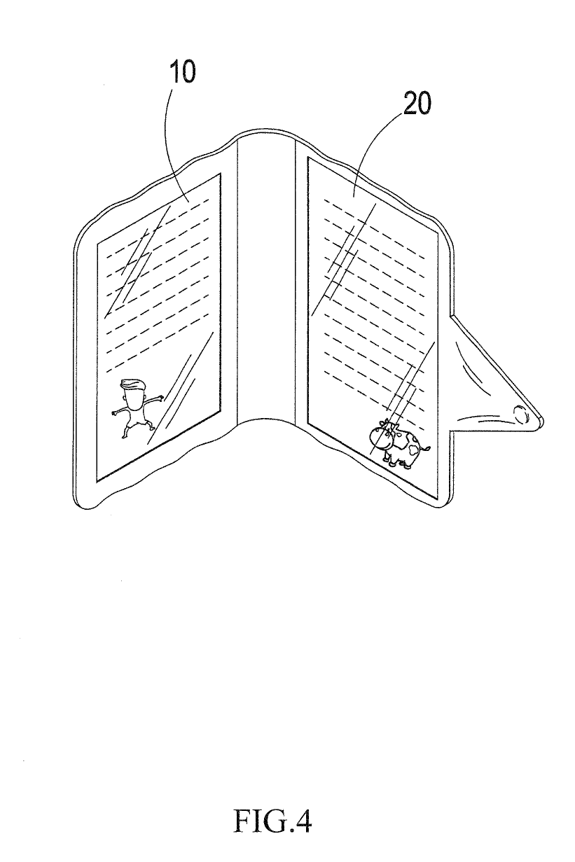

Referring to FIG. 4, a schematic view illustrating an application of the present invention to an electronic book is shown. The drawing clearly shows that the first flexible display module 10 and the second flexible display module 20 are used to display pages of a book, resembling a market-available electronic book. Due to having two display modules, data and information can be displayed in a more versatile fashion.

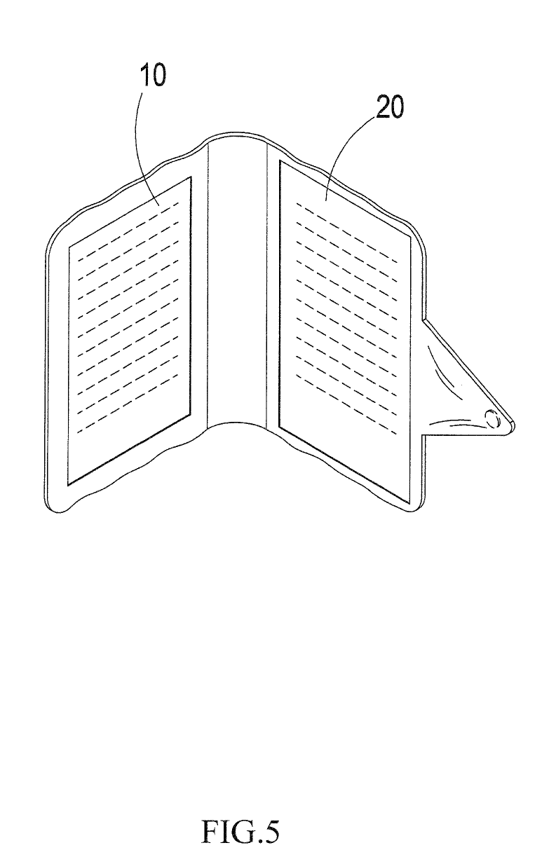

Referring to FIG. 5, a schematic view illustrating an application of the present invention to a notebook is shown. The drawing clearly shows that the first flexible display module 10 and the second flexible display module 20 provide functions of displaying and recording, and can be used to show or record events, serving as a regular electronic notebook available in the market. Due to having two display modules, data and information can be displayed in a more versatile fashion.

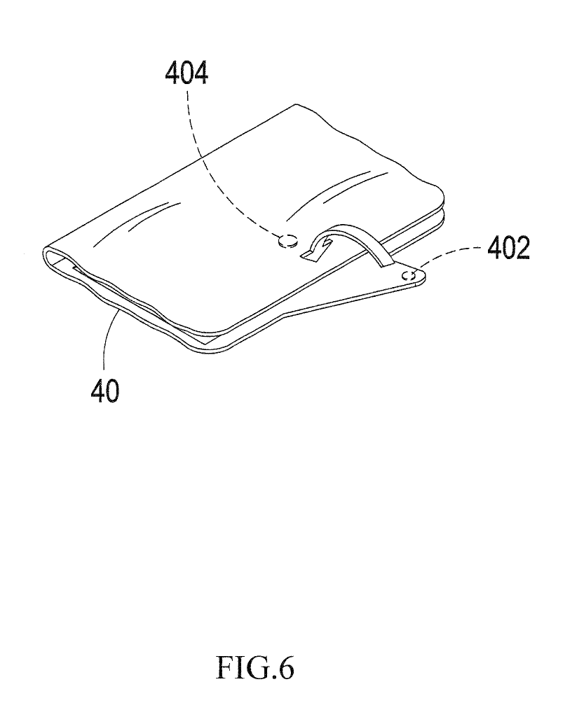

Referring to FIG. 6, a schematic view illustrating a stowed condition of the preferred embodiment of the present invention is shown. Reference is also made to FIG. 1. These drawings clearly show that to stow or close for carrying, the first flexible display module 10 and the second flexible display module 20 are folded to each other to allow the fastening element 402 and the fastened element 404 provided on the enclosure cover 40 to engage and thus couple to each other. This allows of easy carrying by a user.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An application device of electronic paper software, comprising:
a first flexible display module, which has a side forming a second flexible display module; and
a flexible input module, which extends from a side of the second flexible display module for input of information, wherein the first flexible display module and the second flexible display module respectively display different user interfaces and display interfaces.

2. The application device of electronic paper software according to claim 1 further comprising an enclosure cover that is sufficient to cover the first flexible display module, the second flexible display module, and the flexible input module.

3. The application device of electronic paper software according to claim 2, wherein the enclosure cover has a predetermined portion forming a fastening element.

4. The application device of electronic paper software according to claim 2, wherein the enclosure cover has a predetermined portion forming a fastened element.

5. The application device of electronic paper software according to claim 1, wherein the flexible input module alternatively extends from a side of the first flexible display module.
